(19) United States
(12) Patent Application Publication
(10) Pub. No.: US 2004/0178304 A1
(43) Pub. Date: Sep. 16, 2004

(54) Computer mouse pad

(76) Inventor: Paul F. Lando, Red Lion, PA (US)

Correspondence Address: JAMES RAY & ASSOCIATES, 2640 Pitcairn Road, Monroeville, PA, 15146, US

(21) Appl. No.: 10/093,554

(22) Filed: Mar. 8, 2002

Related U.S. Application Data
(62) Division of application No. 29/130,555, filed on Oct. 4, 2000, now abandoned.

(51) Int. Cl. B68G 5/00

(52) U.S. Cl. 248/118; 248/346.01; 248/918

(57) ABSTRACT

An ergonomic apparatus for supporting a computer mouse comprises a base member having a first predetermined shape and a support tray. Such support tray having a second predetermined shape. There is a mousing surface disposed on an upper surface of the support tray and a means engageable with an upper surface of the base member and a bottom surface of the support tray for permitting the support tray to rotate to various positions.

### CROSS REFERENCE TO RELATED APPLICATIONS

The invention taught in this patent application is a divisional application of the invention taught in the following co-pending patent application, COMPUTER MOUSE PAD, Ser. No. 29/130,555 which was filed on Oct. 4, 2000. The invention taught in this patent application is also closely related to the invention taught in the following co-pending patent application, COLLAPSIBLE COMPUTER MOUSE PAD, Ser. No. ______ which is being filed concurrently herewith. These patent applications are assigned to the same assignee and the teachings therein are incorporated into this application by reference thereto.

### FIELD OF INVENTION

The present invention relates, in general, to an a computer mouse pad and, more particularly, the present invention relates to an ergonomic adjustable mouse pad for use with a computer mouse.

### BACKGROUND OF THE INVENTION

Computer users that operate a computer almost entirely with the use of a mouse can be subjected to the same wrist and hand problems that are encountered by typists and others that use keyboards or other equipment in which the wrist is held in one position for a prolonged period of time. Many instances such activity can lead to carpal tunnel syndrome.

It is generally believed that it is the constant angle at which a wrist is subjected to in order to perform the function results in stresses on the wrist that can in some instances be disabling. Therefore, it would be beneficial if it would be possible to perform the mouse function and also provide relief for the wrist.

### SUMMARY OF THE INVENTION

The present invention provides an ergonomic apparatus for supporting a computer mouse. The apparatus comprises a base member having a first predetermined shape and a support tray support tray having a second predetermined shape. There is a mousing surface disposed on at least a portion of the upper surface of the support tray and a means engageable with an upper surface of the base member and with a bottom surface of the support tray for permitting the support tray to rotate to various positions.

In an embodiment of the invention such means is a spherical articulated joint having infinite variable angles for engaging the support tray with the base pad and for permitting the support tray to rotate to any desired angle.

### OBJECTS OF THE INVENTION

It is, therefore, one of the primary objects of the present invention to provide an ergonomic computer mouse pad with a spherically adjustable tilt.

Another object of the present invention is to provide an ergonomic computer mouse pad with a spherically adjustable tilt that is connectable to a computer keyboard tray.

Still another object of the present invention is to provide an ergonomic computer mouse pad with a spherically adjustable tilt that is connectable to a computer keyboard tray and can be stored under the keyboard tray.

Yet another object of the present invention is provide a means for securing such computer mouse when the ergonomic computer mouse pad is stored under the keyboard tray.

It is also an object of the present invention to provide an ergonomic computer mouse pad that is adaptable for either right or left hand use.

An additional object of the present invention is to provide an ergonomic computer mouse pad can aid in reducing or preventing injury due to repetitive motion.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a plan view of a presently preferred embodiment of the invention.

FIG. 2 is a side elevation view of the embodiment shown in FIG. 1.

FIG. 3 is an end view of the embodiment shown in FIG. 1.

FIG. 4 is a bottom view of the preferred embodiment shown in FIG. 1 with the apparatus in a retracted position under a computer keyboard tray.

FIG. 5 is a side elevation view of the embodiment of the invention shown in FIG. 1 with the apparatus in a retracted position under a computer keyboard tray.

FIG. 6 is an end view of the embodiment of the invention shown in FIG. 1 with the apparatus in a retracted position under a computer keyboard tray.

FIG. 7 is top view of the invention according to an alternate embodiment.

FIG. 8 is a side elevation view of the invention according to the alternate embodiment shown in FIG. 7.

FIG. 9 is a bottom view of the invention according to the alternate embodiment shown in FIG. 7.

### BRIEF DESCRIPTION OF THE INVENTION

Prior to proceeding with the more detailed description of the present invention it should be noted that, for the sake of clarity, identical components which have identical functions have been designated by identical reference numerals throughout the several views illustrated in the drawings.

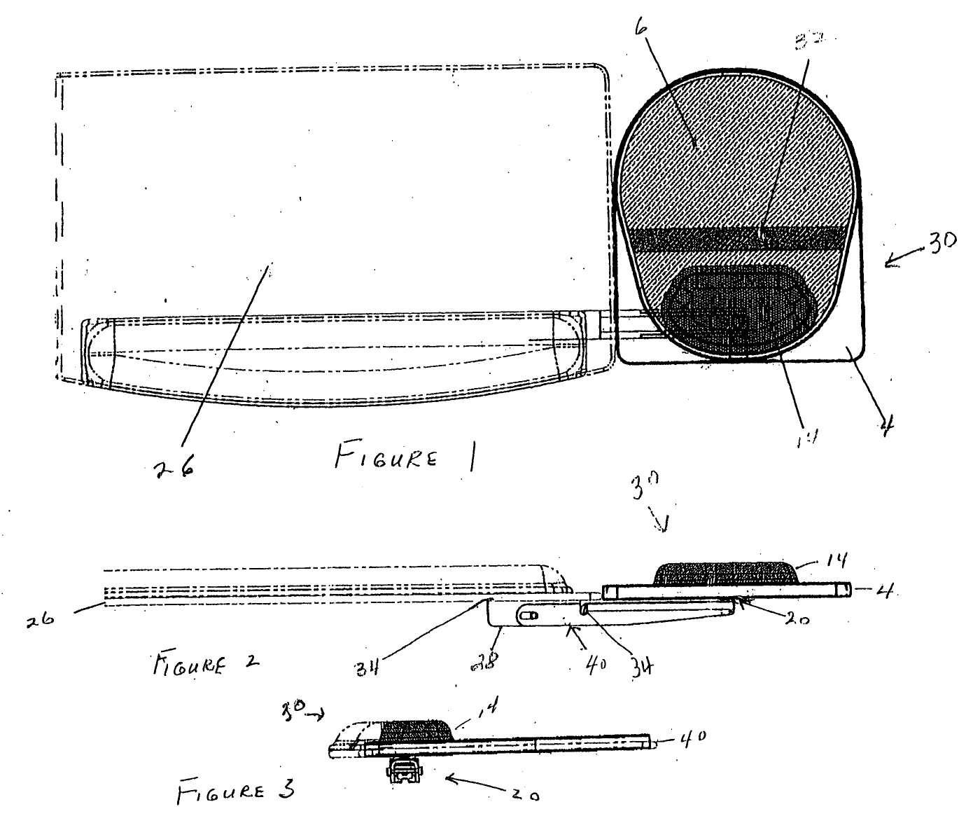

Reference is now made to FIGS. 1 through 6. Illustrated therein is an embodiment of the invention of an apparatus, generally designated 30, for supporting a computer mouse.

The apparatus 30 comprises a support tray 4 having a predetermined shape. Such predetermined shape is generally rectangular. However, such rectangular shape may also have at least one arcuate end. Such shape may be oval or square or any other desired shape. It is presently preferred that there be one arcuate end on such generally rectangular shape. A mousing surface 6 is disposed on at least a portion of the upper surface of the support tray 4.

A mounting assembly, generally designated 40, has a first end 22 and a second end 24. Further, the apparatus includes a first means, generally designated 20, that is disposed adjacent such first end 22 of the mounting assembly 40 for engaging the mounting assembly 40 with the support tray 4 in a position which will permit the support tray 4 to rotate to various positions.

In a presently preferred embodiment of the invention such first means 4 includes a spherical articulated joint 8. Such spherical articulated joint 8 permits such support tray 6 to rotate in any direction and at any angle thus providing infinite variable angles for the support tray 4 to rotate about the base member 2.

The first means 20 further includes a third means 12 for adjusting the resistance on the spherical articulated joint 8. In a presently preferred embodiment of the invention such third means 12 is an Allen screw 12. It is also presently preferred that such Allen screw 12 is engageable with the spherical articulated joint 8 through the mounting assembly 40.

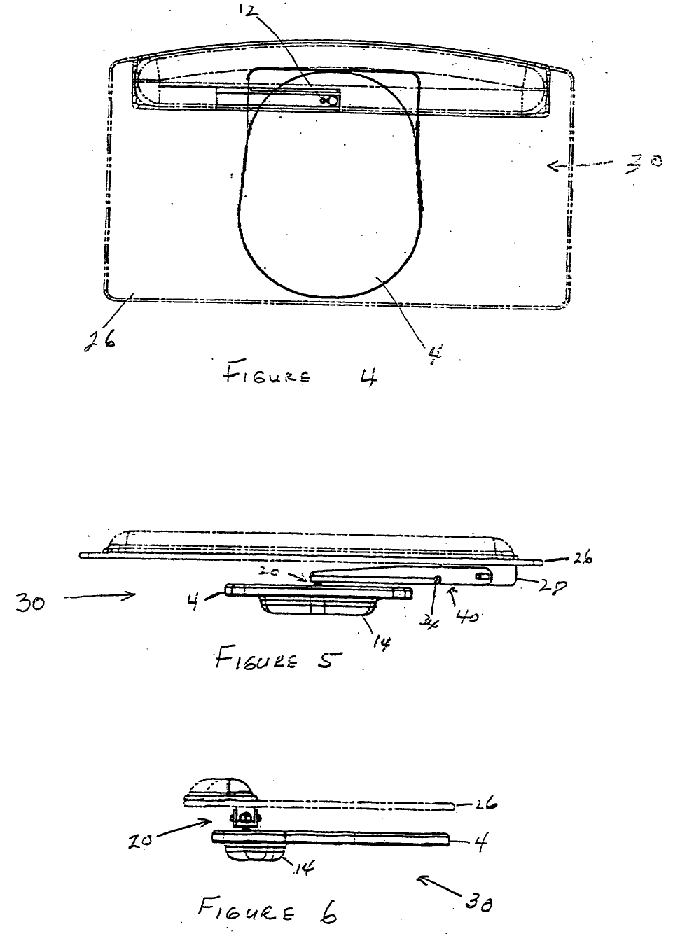

The apparatus 30 further includes a locking hinge mechanism 28 that is rotatingly connected to the second end 24 of such mounting assembly 40. Such locking hinge mechanism 28 permits the apparatus 30 to lock into the position where such apparatus is beside a predetermined member 26 as is seen in FIG. 1 or when the locking hinge mechanism 28 is unlocked and rotated it permits the apparatus 30 to be out of the way and stored in a retracted position under such predetermined member 26 as is evident in FIGS. 4, 5 and 6. Such locking hinge mechanism 28 further includes spring means 34 for providing a bias tension on such rotating portion of such locking hinge mechanism 28. Such predetermined member 26 may be a computer keyboard tray, a shelf or a desktop; however, the most advantageous location is in conjunction with the tray of a computer keyboard.

A second means 34 is engageable with such locking hinge mechanism 28 for securing the mounting assembly 40 to an underside of such computer keyboard tray 28. In an embodiment of the invention such second means 34 is at least one of one an adhesive strip and screws. It is presently preferred that such second means 34 be adhesive strips which permit such locking hinge mechanism 28 to adhere to the underside of such keyboard tray 26. However, such means 34 could also include screws along with such adhesive strips.

In still another embodiment of the invention such support tray 4 further includes a wrist pad 14. It is presently preferred that such wrist pad 14 be mounted on at least a portion of the support tray and be part of such mousing surface 6. Such wrist pad 14 is generally flexible and may be gel filled. In yet another embodiment there is a mouse retaining strap 32 for holding the mouse whenever the apparatus 30 is in a retracted position under the keyboard tray 26. It is presently preferred that such mouse retaining strap 32 is an elastic band.

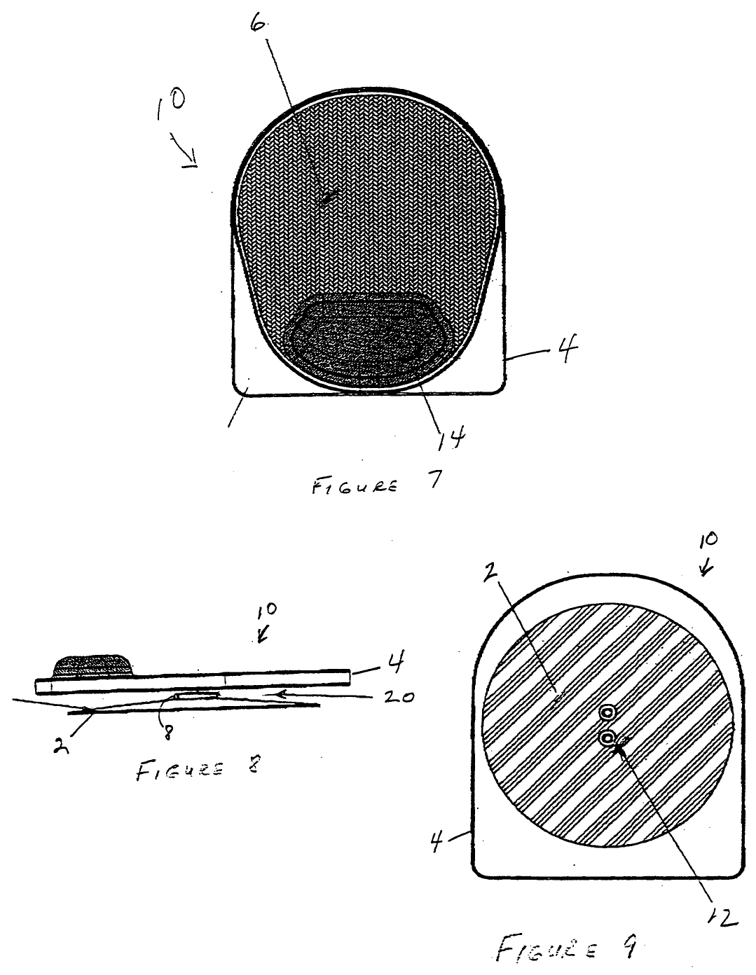

Reference is now made to FIGS. 7-9. Illustrated therein is an alternate embodiment of the invention for an apparatus, generally designated 10, for supporting a computer mouse pad.

The apparatus 10 comprises a base member 2 having a first predetermined shape. In an embodiment of the invention such base member 2 is generally circular and it is generally preferred that the bottom surface of such base member 2 be non skid. Such non skid surface may rubberized material or it may contain at least one suction cup.

The apparatus 10 further has a support tray 4 which has a second predetermined shape. Such second predetermined shape is generally rectangular. However, such rectangular shape may also have at least one arcuate end. Such shape may be oval or square or any other desired shape. It is presently preferred that such shape be generally rectangular with one arcuate end on such generally rectangular shape.

A mousing surface 6 is disposed on the upper surface of such support tray 4. Further, the apparatus includes a means, generally designated 20, engageable with an upper surface of the base member 2 and a bottom surface of the support tray 4 for permitting the support tray 4 to rotate to various positions.

In a presently preferred embodiment of the invention such means 4 includes a spherical articulated joint 8. Such spherical articulated joint 8 permits such support tray 4 to rotate in any direction and at any angle thus providing infinite variable angles for the support tray 4 to rotate about the base member 2.

The means 20 further includes a means for providing a resistance adjustment 12 for the spherical articulated joint 8. In a presently preferred embodiment of the invention such means for providing resistance adjustment 12 is an Allen screw. It is also presently preferred that such Allen screw is engageable with the spherical articulated joint 8 through the base member 2.

In another embodiment of the invention such support tray 4 further includes a wrist pad 14. It is presently preferred that such wrist pad 14 be mounted on at least a portion of the support tray 4 as part of such mousing surface 6. Such wrist pad 14 is generally flexible and may be gel filled.

While both the presently preferred and a number of alternative embodiments of the present invention have been described in detail above it should be understood that various other adaptations and modifications of the present invention can be envisioned by those persons who are skilled in the relevant art without departing from either the spirit of the invention or the scope of the appended claims.

I claim:

1. An ergonomic apparatus for supporting a computer mouse, said apparatus comprising:
(a) a base member, said base member having a first predetermined shape;
(b) a support tray having a second predetermined shape;
(c) a mousing surface disposed on at least a first portion on an upper surface of said support tray; and
(d) means engageable with an upper surface of said base member and a bottom surface of said support tray for both supporting and for permitting said support tray to rotate to various positions.

2. An ergonomic apparatus for supporting a computer mouse, according to claim 1, wherein said means includes a spherical articulated joint.

3. An ergonomic apparatus for supporting a computer mouse, according to claim 2, wherein said spherical articulated joint provides an infinite variable angle for engaging said support tray with said base member.

4. An ergonomic apparatus for supporting a computer mouse, according to claim 2, wherein said spherical articulated joint includes a means for providing a predetermined resistance adjustment for said spherical articulated joint.

5. An ergonomic apparatus for supporting a computer mouse, according to claim 4, wherein said means for providing a resistance adjustment for said spherical articulated joint is an Allen screw.

6. An ergonomic apparatus for supporting a computer mouse, according to claim 5, wherein said Allen screw is engageable with said spherical articulated joint through said base pad.

7. An ergonomic apparatus for supporting a computer mouse, according to claim 1, wherein said support tray further includes a wrist pad disposed on at least a second portion of said upper surface of said support tray.

8. An ergonomic apparatus for supporting a computer mouse, according to claim 7, wherein said wrist pad is disposed on said mousing surface closely adjacent a first end of said mousing surface.

9. An ergonomic apparatus for supporting a computer mouse, according to claim 7, wherein said wrist pad is flexible.

10. An ergonomic apparatus for supporting a computer mouse, according to claim 7, wherein said wrist pad is gel filled.

11. An ergonomic apparatus for supporting a computer mouse, according to claim 1, wherein said apparatus further includes a means for providing a non skid surface disposed on a bottom surface of said base member.

12. An ergonomic apparatus for supporting a computer mouse, according to claim 11, wherein said means for providing a non skid surface is rubber.

13. An ergonomic apparatus for supporting a computer mouse, according to claim 11, wherein said means for providing a non skid surface is at least one suction cup.

14. An ergonomic apparatus for supporting a computer mouse, according to claim 13, wherein said means for providing a non skid surface is a plurality of suction cups.

15. An ergonomic apparatus for supporting a computer mouse, according to claim 1, wherein said first predetermined shape is generally circular.

16. An ergonomic apparatus for supporting a computer mouse, according to claim 1, wherein said second predetermined shape is generally rectangular.

17. An ergonomic apparatus for supporting a computer mouse, according to claim 16, wherein at least one end of said generally rectangular second predetermined shape is generally arcuate.

18. An ergonomic apparatus for supporting a computer mouse, according to claim 17, wherein said generally rectangular second predetermined shape has radius corners on a radially opposed end from said at least one end of said generally rectangular second predetermined shape that is generally arcuate.
